(19) United States
(12) Patent Application Publication
(10) Pub. No.: US 2018/0234203 A1
(43) Pub. Date: Aug. 16, 2018

(54) RADIO FREQUENCY INTERFERENCE SYSTEM AND METHOD OF INTERFERENCE THEREWITH

(71) Applicant: EASYMAP DIGITAL TECHNOLOGY INC., Taichung City (TW)

(72) Inventors: YUAN-CHAN HSIAO, Taichung City (TW); PAO-JUNG WU, Taichung City (TW)

(21) Appl. No.: 15/887,411

(22) Filed: Feb. 2, 2018

Related U.S. Application Data
(60) Provisional application No. 62/460,057, filed on Feb. 16, 2017.

(51) Int. Cl. H04K 3/00; G08B 13/24; B64C 39/02; G01S 19/01

(52) U.S. Cl. CPC H04K 3/92; H04K 3/90; G08B 13/24; F41H 13/0075; G01S 19/015; B64C 2201/146; B64C 39/024

(57) ABSTRACT

A radio frequency (RF) interference system and a method of interference therewith are provided. The RF interference system includes: an RF interference apparatus, for emitting an interferential electromagnetic (EM) wave to an unmanned aerial vehicle (UAV), including an antenna support and at least two antenna modules mounted on the antenna support, the at least two antenna modules being configured to emit RF interference signals with different RF frequencies.

### FIELD OF THE INVENTION

The present application is based on and claims the priority benefit of U.S. Provisional Application No. 62/460,057 filed on Feb. 16, 2017, the entire contents of which are incorporated herein by reference.

### BACKGROUND OF THE INVENTION

### Description of the Prior Art

A radio frequency (RF) interference system may be used to intervene the remote control of or to take over the operation of an UAV by emitting a RF interferential electromagnetic (EM) wave in order to intercept an UAV invading and approaching to a prohibited area such as military bases and airport clear zones. A RF interference device should be able to emit EM wave with the same RF frequency as the operational frequency of the UAV such that an effective interference can be implemented. Most of remote-controlled UAVs (e.g. commercial drones) typically are allowed to operate at frequency of 1.5, 2.4 or 5.8 GHz instead of the other single band of the RF spectrum. In addition, a typical interference device is configured to emit only single band interferential EM wave which is limited for interception of an UAV which can adjust its operational frequency. As a result, a remote-controlled UAV cannot be effectively expelled by the RF interference device that only has single band RF emission.

The present invention is, therefore, arisen to obviate or at least mitigate the above-mentioned disadvantages.

### SUMMARY OF THE INVENTION

The main object of the present invention is to provide a radio frequency (RF) interference system and a method of interference therewith.

To achieve the above and other objects, the present invention provides a radio frequency (RF) interference system, including: a RF interference device, configured for emitting an interferential electromagnetic (EM) wave to an unmanned aerial vehicle (UAV), including an antenna support and at least two antenna modules mounted on the antenna support, the at least two antenna modules being configured to emit RF interference signals with different RF frequencies.

To achieve the above and other objects, the present invention further provides a method of radio frequency interference using the RF interference system mentioned above, including steps of: searching and targeting the UAV; turning on a power switch of the RF interference device to activate the RF interference device when the UAV is targeted; selecting an interference mode, wherein in response to the interference mode the RF interference device provides one of the RF interference signals of the same frequency as the operational frequency of the UAV to take over the UAV.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a schematic representation of a portable RF interference device according to one embodiment of the invention;

FIG. 2 shows a perspective representation of an antenna module in the RF interference device according to one embodiment of the invention;

FIG. 3 shows a control panel of the RF interference device according to one embodiment of the invention;

FIG. 4 shows a supplementary power equipment for the RF interference device according to one embodiment of the invention;

FIG. 5 shows a schematic representation of an integrated portable RF interference system according to another embodiment of the invention;

FIG. 6 shows a perspective representation of an antenna module in the integrated RF interference system according to another embodiment of the invention; and

FIG. 7 is a flow chart of a deployment method to launch a successful RF interference to a UAV by a RF interference system according to one embodiment of the invention.

### DETAILED DESCRIPTION OF THE PREFERRED EMBODIMENTS

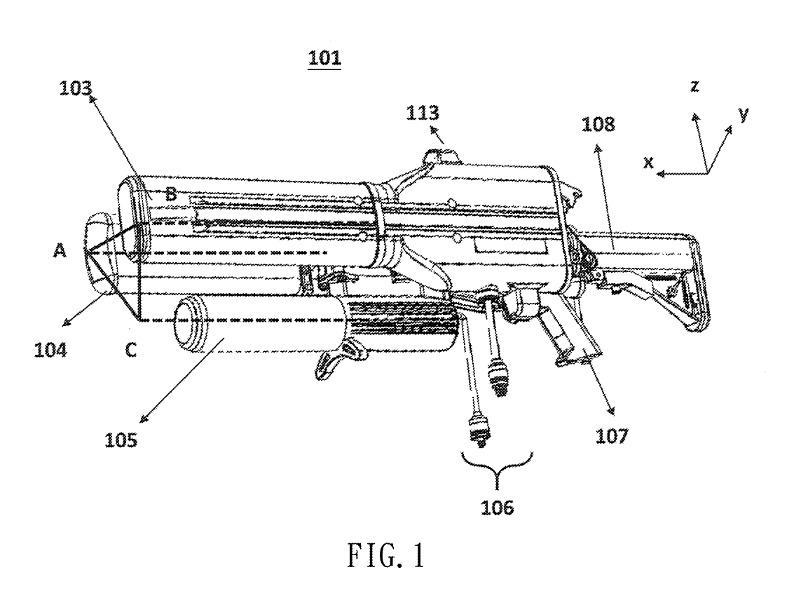

Please refer to FIGS. 1 to 6 for a preferable embodiment of the present invention. The radio frequency (RF) interference system includes a RF interference device, and the RF interference device is configured for emitting an interferential electromagnetic (EM) wave to an unmanned aerial vehicle (UAV). The RF interference device further includes an antenna support and at least two antenna modules mounted on the antenna support, the at least two antenna modules are configured to emit RF interference signals with different RF frequencies. The different RF frequencies emitted from the at least two antenna modules includes at least two of 1.5 GHz, 2.4 GHz and 5.8 GHz.

The invention is directed to a portable RF interference device, system and a method using the same. The RF interference system may be deployed for jamming and intercepting a remote-controlled aerial vehicle which may approach and invade a prohibited area such as military base and airport clear zones. By being equipped with antennas capable of transmitting RF signals that fully cover operational frequency range of the UAVs, the RF interference system may effectively expel the remote-controlled UAVs that operate at different frequencies.

Please refer to FIGS. 1 to 4, in one embodiment of the invention, a radio frequency interference system may include a portable RF interference device for emitting interferential RF EM wave toward an UAV and a supplementary power equipment for supplying power and RF signals to the portable RF interference device. The portable RF interference device may include at least two antenna modules which emit EM wave signals of different RF frequencies toward an UAV and an antenna support that may have rails 109 for the antenna modules to be detachably fixed thereon. The interferential RF wave may be provided from a plurality of RF signal generators installed in the supplementary power equipment, which can produce at least two RF frequency signals required for the antenna modules among RF 1.5 GHz, 2.4 GHz and 5.8 GHz signals.

When the moving UAV is locked in by an operator, the RF interference system may scan over the RF spectrum to find out the current operational frequency used for the moving UAV. Once the current operational frequency is identified, the RF signal generator may generate the RF interference signal of the same frequency as the current operational frequency, and the antenna module will emit interferential RF EM wave to take over the UAV based on the generated RF signals.

The antenna support may be shaped like a rifle providing a grip to easily hold and a sight device to precisely aim at a target UAV for the operator.

Nevertheless, it should be noticed that the antenna support should not be limited to a specific shape as long as the operator can hold the entire RF interference device to target an UAV in a convenient way. In this sense, by standardizing an arbitrary antenna support with unified rails 19 which allow a plurality of antenna modules to be mounted thereon, the antenna modules can be taken along by the operator separately from the antenna support. For example, the unified rails of an arbitrary antenna support may be identical to the ones used for a typical rifle, such as Picatinny rail. In other words, the operator may bring the antenna modules alone without an antenna support and assemble the modules with an arbitrary antenna support that has Picatinny rail at work places. Therefore, only the antenna modules and the supplementary power equipment may be assembled together as a fully functional RF interference system regardless of the provision of the antenna support.

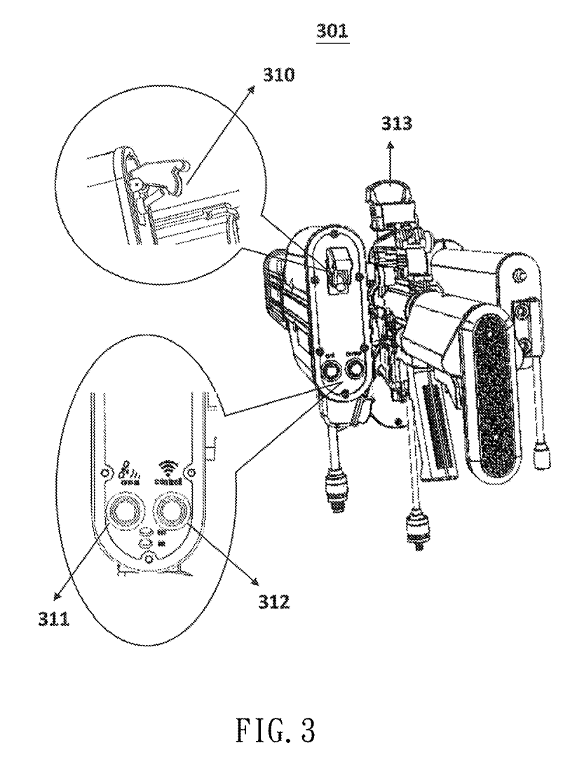

FIG. 1 shows a schematic representation of a RF interference device 101 which has three antenna modules 103, 104 and 105, three RF transmission cables 106 (denoted as a single numeral 106 for brevity) for transmitting high frequency RF signals from RF signal generators to the antenna modules, an antenna support 108 including a grip 107 and rails 109 for the antenna modules 103, 104 and 105 to be mounted thereon. The grip 107 may be further provided with a trigger, and thus the operator may be able to initiate the scanning of the operational frequency of the UAV by pulling the trigger. Each of the antenna modules includes an antenna for emitting interferential RF signal of a specific frequency and a module case to cover the antenna for protection. Each of the RF transmission cable 106 connects one of the antenna modules to a RF signal generator that may be installed in a supplementary power equipment (which will be further illustrated with reference to FIG. 3). The RF interference device may be further provided with a sight device 113 for the operator to better aim at an invading UAV from far distance since a substantially long range can be reached by the interferential RF signals, at which the operator may not catch the UAV easily with naked eyes. The antenna support 108 may be provided with a shoulder stock that gives a means for the operator to firmly support the RF interference device and easily aim the UAV. The shoulder stock also transmits recoil into the operator's body.

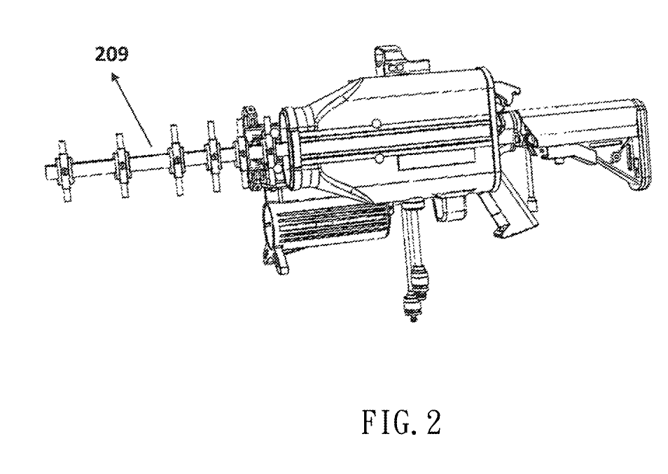

FIG. 2 shows a perspective representation of an antenna module in the RF interference device. Antenna 209 inside the antenna module 104 is configured to emit an interferential RF signal with one of the specific RF band among RF 1.5 GHz, 2.4 GHz and 5.8 GHz signals. For example, the radio frequency for interference covered by the antenna 209 may be set to RF 1.5 GHz; the other two radio frequencies for interference may be covered by the other two antennas inside the antenna modules 103 and 105, respectively.

Since an UAV can be remotely operated with the frequencies of 1.5 GHz, 2.4 GHz and 5.8 GHz RE signals, a RF interference device may be equipped with three antennas to cover full range of the operational frequency for remote control of the UAV. Each antenna emits RF signal corresponding to one of the three operational frequencies of the UAV. A triangle arrangement for the three antenna modules may be provided to the RF interference device, which is represented by a triangle as shown in FIG. 1. Each of the antenna modules may be installed detachably on one vertice of the triangle arrangement via the rails 19 of the antenna support 108. In one exemplary embodiment, antenna module 104 may be installed at vertice A, antenna module 103 may be installed at vertice B and antenna module 105 may be installed at vertice C of the triangle arrangement. Also the geometrical dimensions of the triangle arrangement may be designed such that the RF signals emitted by the three antennas will not interfere with each other and render an effective antenna radiation patterns as well. For example, to form a desired radiation patterns, a distance from vertice A to vertice B is equal to or larger than 10 cm. Furthermore, the triangle arrangement makes the antenna modules be oriented in parallel such that the RF signals emitted by any two of the antennas will not intersect in far field, giving RF emission a more effective far field radiation patterns.

In addition, the interferential RF EM wave emitted from the three antennas may be configured to be polarized transversely (indicated by z-axis shown in FIG. 1) for better RF signal emission.

FIG. 3 shows a control panel of the RF interference device 301 according to one embodiment of the invention. The control panel can be placed on the back panel of one of the antenna modules. Power switch 310 is used to turn on the RF interference device after an invading UAV has been searched. After the RF interference device is turned on, there are basically three modes for selection of the interference frequency on remote control of the UAV.

Firstly, Control mode, which is activated by only pressing control button 312, is to let the UAV lose control from its user and force it to return to home (i.e., its user's place). Secondly, GPS mode, which is activated by only pressing GPS button 311, is to block location positioning function of the UAV. Thirdly, by pressing both the control button 312 and GPS button 311, the invading UAV may be forced to land on the ground immediately by the RF interference device, which may be referred to as GPS+Control mode, Each of the modes optional for the RF interference device corresponds to the interference to different operational frequency of the invading UAV. For example, the GPS mode is configured to block the RF signal of 1.5 GHz from the GPS satellite; the Control mode is configured to block the RF signals of 2.4 and 5.8 GHz from the remote control of the UAV; and the GPS+Control mode is configured to block signals of all the three frequency from the remote control of the UAV

A sight device 313 is shown again in FIG. 3 for a better illustration in comparison with FIG. 1.

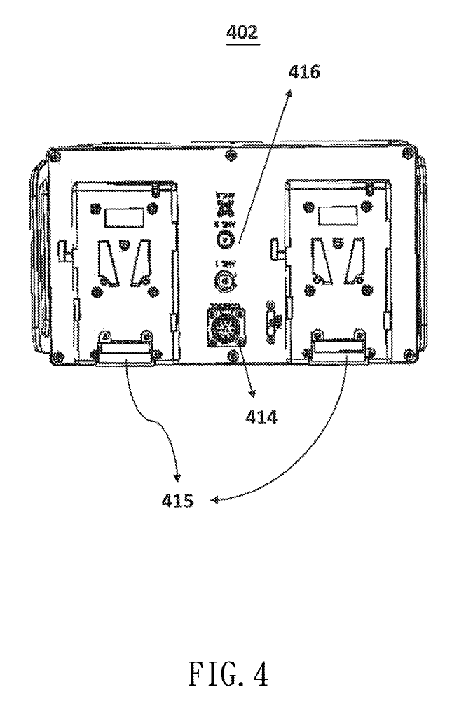

FIG. 4 shows a supplementary power equipment 402 for the RF interference system according to one embodiment of the invention. The supplementary power equipment 402 primarily comprises an interference controller that may scan over the RF spectrum in search of the operational frequency used for the UAV, RF signal generators to produce the RF signals out of RF 1.5, 2.4 and 5.8 GHz, signal amplifiers to amplify the generated RF interference signals, two battery panels 415 on which battery packs can be installed as power supply, a control line connector 414 which supplies battery power to the RF interference device via a power cable and cable connectors 416, each outputting the amplified RF interference signal to the antenna modules. The scanning by the interference controller may be configured to be faster than the change in operational frequency of the target UAV.

In another embodiment of the invention, the supplementary power equipment may be integrated into the RF interference device as an all-in-one RF interference system. For this all-in-one RF interference system, the power supply, the RF signal generator and signal amplifiers are integrated therein such that the connection cables and wires between the components of the system can be shortened greatly, reducing power loss during the power and signal transmission throughout the RF interference system.

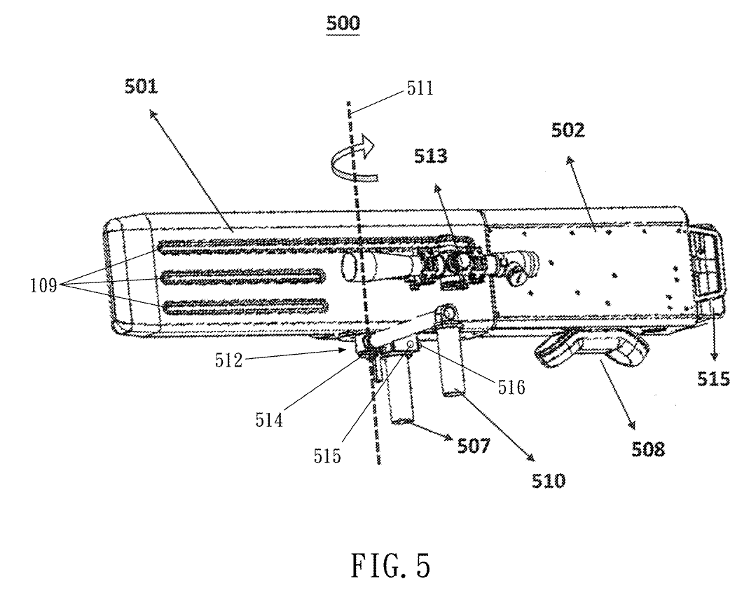

FIG. 5 shows a schematic representation of an integrated portable RF interference system 500 according to another embodiment of the invention. The main body of the integrated portable RF interference system 500 may comprise an antenna portion 501 and a supplementary power portion 502. The antenna portion 501 includes the three antennas that emit RF 1.5, 2.4 and 5.8 GHz interferential signals individually, which are covered by the module case. The corresponding signal generators and the signal amplifiers may be included in the supplementary power portion 502, where the requirement of signal transmission cables is greatly reduced. A sight device 513 may be provided on one side of the integrated interference system 500. A battery pack 515 may be installed on the back end of the integrated system 500. A shoulder stock 508 may be mounted on the operator's shoulder to firmly support the integrated system 500 when targeting the moving UAV. A grip 507 is designed for the operator to easily hold the integrated system 500.

For the operation of the integrated RF interference system 500, the system 500 is turned on by rotating power switch bar 510 with respect to the rotation axis 511 from a standby position to a power-on position. In FIG. 5, the arrow around the axis (shown as dashed line) indicates the rotational direction from the standby position to the power-on position. The standby position may be located right below the body of the antenna portion 501, and the power-on position may be located on the current position of the power switch bar 510 as shown in FIG. 5. When the power switch bar 510 reaches the power-on position, the scanning of the UAV operational frequency may be initiated automatically or manually with a trigger.

The power switch bar 510 has a pivotal portion 512 exactly on the down side of the antenna portion 501, and the pivotal portion 512 may be configured to have a push button 514 for locking and unlocking the rotation of the power switch bar 510. For example, as the push button 514 is pressed by the operator, the power switch bar 510 is allowed to be rotated from the standby position to the power-on position, and the integrated RF interference system is turned on accordingly. Furthermore, a GPS button 515 and a Control button 516 may be arranged near the grip 507 on the down side of the antenna portion 501. The three modes (i.e., Control mode, GPS mode and GPS+Control mode) for selection of the interference frequency on remote control of the UAV may be determined by pressing either the GPS button 515, Control button 516 or both after the power switch bar 510 is rotationally switched to the power-on position.

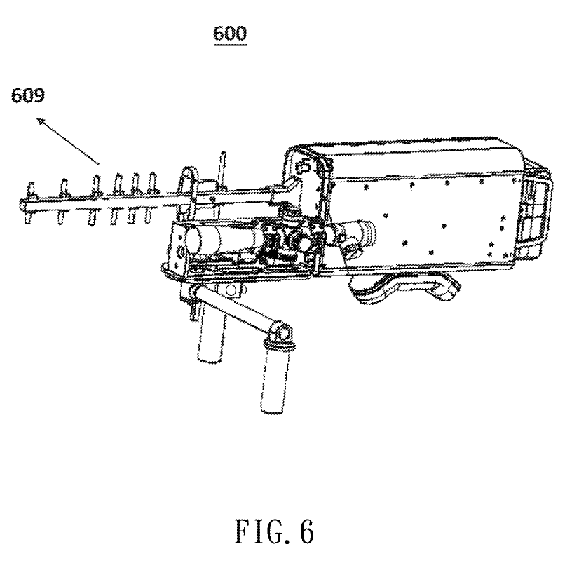

FIG. 6 shows a perspective representation of the antenna portion in an integrated RF interference system 600 according to another embodiment of the invention. In FIG. 6, the antenna 609 is only shown for illustrative purpose. There are actually three antennas arranged inside the antenna portion for the integrated RF interference system 600. The three antennas for the integrated RF interference system 600 may be arranged specifically to ensure that the RF emission at 1.5, 2.4 and 5.8 GHz band will not interfere each other after emission.

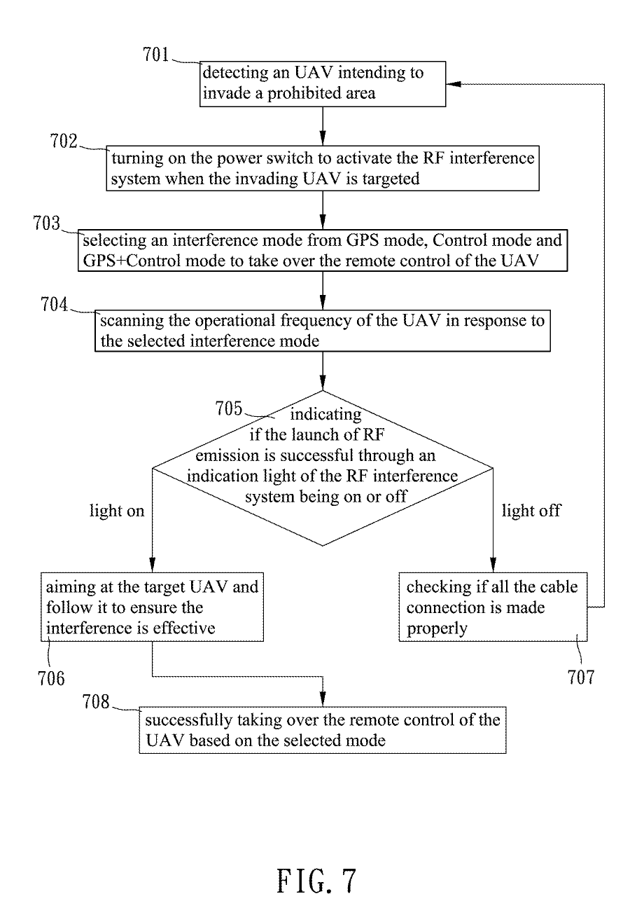

FIG. 7 is a flow chart of a deployment method to launch a successful RF interference to a UAV by a RF interference system according to one embodiment of the invention. Upon detecting an UAV intending to invade a prohibited area, an operator, carrying a portable RF interference system, searches for the invading UAV in a visible distance with or without a sight device at step 701. As the invading UAV is targeted by the operator, the power switch is turn on to activate the RF interference system at step 702. Then, the interference mode is selected out from GPS mode, Control mode and GPS+Control mode to take over the remote control of the UAV at step 703. In response to the selected interference mode, the scanning of the operational frequency of the UAV is carried out with a trigger of the interference system at step 704. An indication light of the RF interference system will be on or off to indicate if the launch of RF emission is successful at step 705. If the light on, the operator aims at the target UAV and follow it to ensure the interference is effective at step 706. Then, the remote control of the UAV is successfully taken over based on the selected mode at step 708. If the light is off, the operator checks if all the cable connection is made properly at step 707 and go to step 701 again.

Typically, an unauthorized UAV is approaching a prohibited area from a far place. To effectively detect the UAV before it approaches at proximity of the prohibited area, a detection system may be needed as a radar network to catch the suspected UAV far away from the prohibited area in advance. In a further embodiment of the invention, the RF interference system may co-work with an UAV detection system. The UAV detection system monitors periodically whether a suspected flying object approaches the prohibited area. If the detection system finds an approaching UAV suspected as an invading UAV, an alerting signal will be sent from the detection system to the RF interference system carried by an operator who may or may not be near the approaching UAV. The RF interference system may be further configured such that it may notify the operator with a warning sound or light after receiving the alerting signal. After the operator is notified by the RF interference system on hand, the operator can look to search for the UAV with a sight device or naked eyes. Once the operator targets the UAV, the RF interference operation can be implemented.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A radio frequency (RF) interference system, including:
a RF interference device, configured for emitting an interferential electromagnetic (EM) wave to an unmanned aerial vehicle (UAV), including an antenna support and at least two antenna modules mounted on the antenna support, the at least two antenna modules being configured to emit RF interference signals with different RF frequencies.

2. The RF interference system of claim 1, wherein the different RF frequencies emitted from the at least two antenna modules includes at least two of 1.5 GHz, 2.4 GHz and 5.8 GHz.

3. The RF interference system of claim 1, wherein a number of the at least two antenna modules is three, the antenna modules are disposed respectively on three vertices of a triangle, the three vertices includes vertices A, B and C, and a distance from vertice A to vertice B is equal to or larger than 10 cm.

4. The RF interference system of claim 1, wherein the antenna support includes a plurality of rails, the rails are unified rails, and each of the at least two antenna modules is detachably mounted on one of the plurality of rails.

5. The RF interference system of claim 1, further including a supplementary power equipment, the supplementary power equipment being connected with the RF interference device and configured to supply power and the RF interference signals to the RF interference device.

6. The RF interference system of claim 5, wherein the supplementary power equipment includes a plurality of RF signal generators for generating the RF interference signals.

7. The RF interference system of claim 6, wherein the supplementary power equipment further includes an interference controller, a plurality of signal amplifiers, a plurality of battery panels and a control line connector, the interference controller is configured to scan over the RF spectrum in search of the operational frequency used for the UAV, the plurality of RF signal generators are configured to produce the RF interference signals of RF 1.5, 2.4 and 5.8 GHz, the plurality of signal amplifiers are configured to amplify the RF interference signals, the plurality of battery panels include a plurality of battery packs, the control line connector is configured to supply battery power to the RF interference device via a power cable and cable connectors, and each of the RF interference signals which is amplified is transmitted to the antenna modules.

8. The RF interference system of claim 1, wherein the RF interference device further includes a control button and a GPS button, the RF interference device is activated into a Control mode by only pressing the control button so as to let the UAV lose control from its user and force it to return to home the RF interference device is activated into a GPS mode by only pressing the GPS button so as to block location positioning function of the UAV, and the RF interference device is activated into a GPS+Control mode by pressing the control button and the GPS button so as to force the UAV to land on the ground immediately.

9. The RF interference system of claim 1, wherein the RF interference device further includes a shoulder stock configured to be mounted on the operator's shoulder, and a grip configured for grip.

10. The RF interference system of claim 1, wherein the RF interference device includes an antenna portion which includes the at least two antenna modules, the RF interference device further includes a power switch bar, the power switch bar is rotatable with respect to a rotation axis between a standby position to a power-on position, the power switch bar has a pivotal portion on the down side of the antenna portion, and the pivotal portion includes a push button configured for locking and unlocking the rotation of the power switch bar.

11. A method of radio frequency interference using the RF interference system of claim 1, including steps of:
searching and targeting the UAV;
turning on a power switch of the RF interference device to activate the RF interference device when the UAV is targeted;
selecting an interference mode, wherein in response to the interference mode the RF interference device provides one of the RF interference signals of the same frequency as the operational frequency of the UAV to take over the UAV.

12. The method of claim 11, further including a step of: using the RF interference system to co-work with an UAV detection system to monitors periodically whether an approaching UAV approaches a prohibited area, if the detection system finds the approaching UAV suspected as an invading UAV, an alerting signal is sent from the detection system to the RF interference system, and after receiving the alerting signal, the RF interference system sends out a warning sound or light.
